(19) United States
(12) Patent Application Publication
(10) Pub. No.: US 2026/0204642 A1
(43) Pub. Date: Jul. 16, 2026

(54) SUPERCONDUCTING SOLID STATE ELECTROLYTES WITH LOW ACTIVATION ENERGIES

(71) Applicant: Toyota Motor Engineering & Manufacturing North America, Inc., Plano, TX (US)

(72) Inventors: Rana Mohtadi, Northville, MI (US); Oscar Tutusaus, Ann Arbor, MI (US); Jian Pan, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/532,359

(22) Filed: Feb. 6, 2026

Related U.S. Application Data
(63) Continuation-in-part of application No. 19/358,619, filed on Oct. 15, 2025.
Application No. 19/358,619 is a continuation of application No. 17/846,334, filed on Jun. 22, 2022, now Pat. No. 12,469,884.

(51) Int. Cl. H01M 10/0568; H01M 10/052; H01M 10/0562; H01M 10/39

(52) U.S. Cl. CPC H01M 10/0568; H01M 10/052; H01M 10/0562; H01M 10/399; H01M 2300/0048; H01M 2300/0065

(57) ABSTRACT

An electrolyte includes a composite salt mixture with between 0.975 and 0.05 mole fraction, relative to a total anion content of the composite salt mixture, of a halogen-free boron cluster salt (e.g., a halogen-free closo-borate salt) and between 0.025 and 0.95 mole fraction, relative to the total anion content of the composite salt mixture, of a halogenated boron cluster salt (e.g., a halogenated closo-borate salt), a solvent content between 0.01 mol % and 100 mol % relative to a total cation content of the electrolyte, and an activation energy less than 0.65 electron volts (eV) at one or more temperatures above −30° C.

### CROSS-REFERENCE TO RELATED APPLICATION

This application is a continuation-in-part application of currently pending U.S. patent application Ser. No. 19/358,619, filed on Oct. 15, 2025, which is a continuation application of U.S. patent application Ser. No. 17/846,334, filed on Jun. 22, 2022, now U.S. Pat. No. 12,469,884, issued on Nov. 11, 2025, both of which are incorporated herein in their entirety by reference.

### TECHNICAL FIELD

The present disclosure generally relates to solid state electrolytes, and particularly to superconducting solid state electrolytes.

### BACKGROUND

Solid-state electrolytes provide many advantages in secondary battery design, including mechanical stability, no volatility, and ease of construction. Typical inorganic solid-state electrolytes having high ionic conductivity are sulfides-based electrolytes. For example, Zhang et al. reported that the ionic conductivity for a sulfide electrolyte can exceed 25 mS/cm, which is advantageous for battery applications (Zhang Z et al. Energy Environ. Sci., 2018, 11, 1945). However, sulfide-based electrolytes suffer from the high propensity to form H₂S toxic gases upon exposure to low levels of moisture, which challenges their practical use. Other classes such as polymeric and other organic-based electrolytes have inferior ionic mobility at technologically relevant temperatures below 60° C.

The present disclosure addresses these issues with solid-state electrolytes, and other issues related to electrolytes.

### SUMMARY

In one form of the present disclosure, an electrolyte includes a composite salt mixture with between 0.975 and 0.05 mole fraction, relative to a total anion content of the composite salt mixture, of a halogen-free boron cluster salt (e.g., a halogen-free closo-borate salt) and between 0.025 and 0.95 mole fraction, relative to the total anion content of the composite salt mixture, of a halogenated boron cluster salt (e.g., a halogenated closo-borate salt), a solvent content between 0.01 and 100 mol % relative to a total cation content of the electrolyte, and an activation energy less than 0.65 electron volts (eV) at one or more temperatures above −30° C.

In another form of the present disclosure, an electrochemical cell includes an anode, a cathode, and a solid state electrolyte. The solid state electrolyte includes a composite salt mixture with between 0.975 and 0.05 mole fraction, relative to a total anion content of the composite salt mixture, of a halogen-free boron cluster salt and between 0.025 and 0.95 mole fraction, relative to the total anion content of the composite salt mixture, of a halogenated boron cluster salt of the solid state electrolyte, and a solvent content between 0.01 and 100% mol relative to a total cation content of the solid state electrolyte. Also, the solid state electrolyte has an activation energy less than 0.65 eV at one or more temperatures above −30° C.

In still another form of the present disclosure, a method includes mixing a halogen-free boron cluster salt, a halogenated boron cluster salt, and a solvent in a mechanochemical synthetic ball mill and forming an inorganic boron cluster solid state electrolyte. The content or amount of the halogen-free boron cluster salt is between 0.975 and 0.05 mole fraction, relative to a total anion content of the solid state electrolyte, the content or amount of the halogenated boron cluster salt is between 0.025 and 0.95 mole fraction, relative to the total anion content of the solid state electrolyte, and the content or amount of the solvent is between 0.01 and 100 mol % relative to a total cation content of the solid state electrolyte. The inorganic boron cluster solid state electrolyte, when heated up to a temperature at or below 200° C., and cooled, has an activation energy that is less than an activation energy of the solid state electrolyte before being annealed. In another variation, prior to applying the mechanochemical synthesis, a premixing step is applied for a halogen-free boron cluster salt, a halogenated boron cluster salt, and solvent in a mortar and pestle, followed by heating up to 150 C for up to 24 hours.

In another form, the solvents can also be present in the boron cluster salt as an impurity carried over from the synthesis utilized to prepare the precursors.

These and other features of the nearly solvent-free combined salt electrolyte and its preparation will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 is an Arrhenius plot of cationic conductivity versus temperature for a halogen-free boron cluster salt, and a composite salt mixture of the halogen-free boron cluster salt and a halogenated boron cluster salt according to the teachings of the present disclosure;

FIG. 2 is an Arrhenius plot of cationic conductivity versus temperature for a halogen-free boron cluster salt, and another composite salt mixture of the halogen-free boron cluster salt and a halogenated boron cluster salt according to the teachings of the present disclosure;

FIG. 3 is a plot of cationic conductivity (solid line) and activation energy (dashed line) versus mol % content of the halogenated boron cluster salt LiCB₁₁H₁₁F in a LiCB₁₁H₁₂/LiCB₁₁H₁₁F composite salt mixture;

FIG. 4A is a ¹H nuclear magnetic resonance (NMR) spectrum of a composite salt mixture of a halogen-free boron cluster salt and a halogenated boron cluster salt with 0.39 mole percent (mol %) of tetrahydrofuran (THF) and 0.11 mol % water (H₂O) according to the teachings of the present disclosure;

FIG. 4B is an Arrhenius plot of conductivity versus inversus temperature for the composite salt mixture of the halogen-free boron cluster salt and the halogenated boron cluster salt with 0.39 mol % THF and 0.11 mol % water (H₂O) in FIG. 4A;

FIG. 5A is a ¹H NMR spectrum of a composite salt mixture of a halogen-free boron cluster salt and a halogenated boron cluster salt with 1.82 mol % THF and 0.49 mol % water (H₂O) according to the teachings of the present disclosure;

FIG. 5B is an Arrhenius plot of conductivity versus inversus temperature for the composite salt mixture of the halogen-free boron cluster salt and the halogenated boron cluster salt with 1.82 mol % THF and 0.49 mol % water (H₂O) in FIG. 5A;

FIG. 6A is a ¹H NMR spectrum of a composite salt mixture of a halogen-free boron cluster salt and a halogenated boron cluster salt with 2.46 mol % THF and 0.21 mol % water (H₂O) according to the teachings of the present disclosure;

FIG. 6B is an Arrhenius plot of conductivity versus inversus temperature for the composite salt mixture of the halogen-free boron cluster salt and the halogenated boron cluster salt with 2.46 mol % THF and 0.21 mol % water (H₂O) in FIG. 6A; and

FIG. 7 shows an electrochemical device according to the teachings of the present disclosure.

It should be noted that the figures set forth herein are intended to exemplify the general characteristics of the composite salt mixtures, electrolytes, devices, and methods among those of the present technology, for the purpose of the description of certain aspects. The figures may not precisely reflect the characteristics of any given aspect and are not necessarily intended to define or limit specific forms or variations within the scope of this technology.

### DETAILED DESCRIPTION

In an effort to overcome the issues related to sulfide-based electrolytes noted above, polymeric electrolytes and other organic electrolytes have been studied but found to exhibit inferior ionic mobility at technologically relevant temperatures below 60° C. And recently, boron cluster salts have been reported to possibly form superionic conductors at above 50° C., and for many of these salts at above 120° C. In some instances, these super conductor high temperature phases can be stabilized at room temperature for limited closo-borate salts (e.g., see U.S. Pat. No. 10,553,897; Kim S. et al. Nature Communications 10:1081, 2019; Tang W. S. et al. ACS Energy Lett. 2016, 1, 659-664). However, such an approach is problematic as the ionic conduction property, which includes the activation energy, is dictated by the intrinsic property and structural features of the high temperature phases. In fact, salts of closo borates, and also most polymeric and other solid-state inorganic electrolytes, generally exhibit relatively high activation energies for cationic mobility at temperatures below 60° C., which in turn implies a strong effect of the temperature on cationic mobility, a property not desired for device operation. For example, the lowest activation energy for a room temperature superionic closo-borate lithium cation conductor has been reported to be greater than 0.29 eV (Kim S. et al., Nature Communications 10:1081, 2019). And the activation energy for lirhium (Li) closo carborane salts exceeded 0.31 eV for temperatures above 39° C. and increased to 0.74 eV as these electrolytes were cooled below 39° C. (Tang W. S. et al. ACS Energy Lett. 2016, 1, 659-664).

In contrast to previous teachings, the present disclosure provides electrolytes with low activation energies (i.e., less than 0.65 eV) that include a composite salt mixture in which at least two different salts are in direct contact with each other, e.g., the composite salt mixture includes a combination of two or more boron cluster salts such as two or more closo-borate salts. In some variations, a composite salt mixture includes a halogen-free boron cluster salt and a halogenated boron cluster salt (also referred to herein simply as “combined halogen-free boron cluster/halogenated boron cluster salt”) and the combined halogen-free boron cluster/halogenated boron cluster salt provides an inorganic boron cluster solid state electrolyte with a cationic conductivity that is at least one order of magnitude greater than a cationic conductivity of the halogen-free boron cluster salt, at least one order of magnitude greater than a cationic conductivity of the halogenated boron cluster salt, and low activation energies (e.g., less than 0.65 eV). In addition, electrolytes with the “combined halogen-free boron cluster/halogenated boron cluster salt” can exhibit and/or maintain relatively low activation energies at high temperature (e.g., up to 150° C.) and sub-ambient temperatures (e.g., down to −30° C.). It should be understood that such composite salt mixtures can include only two boron cluster salts or more than two boron cluster salts, e.g., only three boron cluster salts, only four boron cluster salts, etc.

In some variations, and in contrast to traditional teachings on the synthesis and use of solid state electrolytes, the electrolytes according to the teachings of the present disclosure include trace amounts of one or more solvents (simply referred to herein as “solvent” unless otherwise noted). And in at least one variation the electrolytes include more than trace amounts of one or more solvents. For example, and regarding the traditional teachings on the synthesis and use of solid state electrolytes, solvents are used in synthesis and processing of solid state electrolytes in order to provide or enhance formation of a homogeneous and ionically conductive solid matrix. However, such solvents are typically removed after synthesis of a solid state electrolyte in order to enhance electrochemical stability and mechanical strength, avoid degradation and side reactions, and/or enhance ion conductivity of the solid state electrolyte. However, the inventors have discovered that trace amounts of solvents, which may or may not be used to assist in the synthesis or a solid state electrolyte, do not degrade, and in fact can enhance properties of inorganic boron cluster solid state electrolytes disclosed herein.

Accordingly, the inorganic boron cluster solid state electrolytes disclosed herein include a desired solvent content. Non-limiting examples of the solvent include an ether solvent, an amine solvent, an amide solvent, a sulfoxide solvent, a sulfone solvent, a sulfonamide solvent, a ketone, a phosphate, a phosphite, a carbonate solvent, a nitrile solvent, an ester solvent, an aliphatic solvent, an aromatic hydrocarbon solvent, an ion-solvating oligomer, an ion-solvating polymer, protic solvent such as water, acetone, alcohol, ammonia, and combinations thereof. Also, the desired solvent content can be between 0.01 mol % and 100 mol % relative to a total cation content of the inorganic boron cluster solid state electrolytes disclosed herein, including all subranges therebetween e.g., between 0.01 to 1 mol %, between 1.0 to 2.0 mol %, between 2.0 to 4.0 mol %, between 4.0 to 6.0 mol %, between 6.0 to 10.0 mol %, between 10.0 to 15.0 mol %, between 15.0 to 20.0 mol %, between 20.0 to 25.0 mol %, between 25.0 to 30.0 mol %, between 30.0 to 35.0 mol %, between 35.0 to 40.0 mol %, between 40.0 to 50.0 mol %, between 50.0 to 60.0 mol %, between 60.0 to 70.0 mol %, between 70.0 to 80.0 mol %, between 80.0 to 90.0 mol %, between 90.0 to 100.0 mol %, between 0.01 to 90.0 mol %, between 0.01 to 80.0 mol %, between 0.01 to 70.0 mol %, between 0.01 to 60.0 mol %, between 0.01 to 50.0 mol %, between 0.01 to 40.0 mol %, between 0.01 to 30.0 mol %, between 0.01 to 20.0 mol %, between 0.01 to 15.0 mol %, between 0.01 to 10.0 mol %, or between 0.01 to 5.0 mol %.

In some variations of the present disclosure, the halogen-free boron cluster salt includes a monovalent or multivalent cation selected from Li⁺, Na⁺, K⁺, Mg²⁺, Ca²⁺, Zn²⁺ and Al³⁺, and a boron cluster anion with the structure [B_{y}H_{(y-z)}R_{z}]²⁻, [CB_{(y-1)}H_{(y-z)}R_{z]}⁻, [C₂B_{(y-2)}H_{(y-t-1)}Rₜ]⁻, [C₂B_{(y-3)}H_{(y-t)}Rₜ]⁻, or [C₂B_{(y-3)}H_{(y-t-1)}Rₜ]²⁻, and where y is an integer within a range of 6 to 12, (z) is an integer within a range of 0 toy, (t) is an integer within a range of 0 to (y-1), and R is a linear, branched-chain, or cyclic C1-C18 alkyl or fluoroalkyl group. And in at least one variation, the halogenated boron cluster salt includes a cation selected from Li⁺, Na⁺, K⁺, Mg²⁺, Ca²⁺, Zn²⁺ and Al³⁺, and a boron cluster anion with the structure [B_{y}H_{(y-z-i)}R_{z}X,]²⁻, [CB_{(y-1)}H_{(y-z-i)}R_{z}Xᵢ]⁻, [C₂B_{(y-2)}H_{(y-t-1)}RₜXⱼ]⁻, [C₂B_{(y-3)}H_{(y-t-j)}RₜXⱼ]⁻, or [C₂B_{(y-3)}H_{(y-t-1)}RₜXⱼ]²⁻, and where y is an integer within a range of 6 to 12, (z+i) is an integer within a range of 0 toy, (t+j) is an integer within a range of 0 to (y-1), X is F, Cl, Br, I, or a combination thereof, and R is a linear, branched-chain, or cyclic C1-C18 alkyl or fluoroalkyl group. In the alternative, X is a halogenated alkyl group containing CF₃. For example, in some variations the boron cluster anion of the halogen-free boron cluster salt and/or the halogenated boron cluster salt is B₁₂H₁₂²⁻, B₁₀H₁₀²⁻, CB₁₁H₁₂⁻ or CB₉H₁₀⁻, or a substituted derivative thereof. It should be understood that the boron clusters anions, such as B₁₂H₁₂²⁻, B₁₀H₁₀²⁻, CB₁₁H₁²⁻, and CB₉H₁₀⁻, are attractive for solid-state batteries since such anions have better chemical stability. In another variation, the borate is not necessarily a closed cage “closo” and can be represented by any of the borate anion structures noted above.

A cation of the halogen-free boron cluster salt can be the same or different than a cation of the halogenated boron cluster salt. Accordingly, an electrolyte formulation with the composite salt mixture can include multiple different boron cluster anions and multiple different cations. The cation population of the electrolyte is composed of one or more cation species selected from the group consisting of Li⁺, Na⁺, K⁺, Mg²⁺, Ca²⁺, Zn²⁺, and/or Al³⁺, and wherein any single selected cation species may constitute from about 1 mol % to 100 mol % of the total moles of cations in the cation population.

In some variations, an electrolyte is formulated from the composite salt mixture of two or more boron cluster salts as noted above, with a desired amount of solvent, and one or more additional cation conductivity enhancing anions. A mole fraction of the one or more additional conductivity enhancing anions relative to the total anions in the composite salt mixture can be from about 0.01 to about 0.9. Also, the one or more additional conductivity enhancing anions can be selected from F⁻, Cl⁻, Br⁻, I⁻, RₓBF₄₋ₓ⁻, R_{y}PF_{6-y}⁻, SbF₆⁻, ClO₄⁻, SO₄²⁻, N(SO₂F)₂⁻, N(SO₂(CF₂)ₙCF₃)₂⁻, [NSO₂(CF₂)ₙ₊₁SO₂]⁻, or CF₃(CF₂)ₙSO₃⁻, where: n is 0 to 5; x is 0 to 4; y is 0 to 6; and R is a linear, branched, or cyclic alkyl group that can be unsubstituted, partially fluorinated, or fully fluorinated.

In at least one variation, an electrolyte is formulated from the composite salt mixture of two or more boron cluster salts as noted above, with a desired amount of solvent, and an addition of an organic plastic crystal such that a soft solid electrolyte with appreciable cation conductivity(ies) is provided. The organic plastic crystal material can be a succinonitrile-glutaronitrile mixture with a content or concentration between 0.01 to 50 molar % of the electrolyte and the plastic state (i.e., the organic plastic crystal) promotes cation conductivities of more than 10⁻⁷/cm at 60° C. And in some variations, the electrolyte includes the composite salt mixture of two or more boron cluster salts, the organic plastic crystal, and the one or more additional cation conductivity enhancing anions.

In at least one variation, an electrolyte is formulated from the composite salt mixture of two or more boron cluster salts, with a desired amount of solvent, and an addition of an inorganic-organic plastic crystal such that a soft solid electrolyte with appreciable cation conductivity(ies) is provided. The inorganic-organic plastic crystal material can include an organic cation(s) such as ammonium, pyridinium, piperidinium, phosphonium and inorganic anions such F⁻, Cl⁻, Br⁻, I⁻, RₓBF₄₋ₓ⁻, R_{y}PF_{6-y}⁻, SbF₆⁻, ClO₄⁻, SO₄²⁻, N(SO₂F)₂⁻, N(SO₂(CF₂)ₙCF₃)₂⁻, [NSO₂(CF₂)ₙ₊₁SO₂]⁻, or CF₃(CF₂)ₙSO₃⁻, where: n is 0 to 5; x is 0 to 4; y is 0 to 6; and R is a linear, branched, or cyclic alkyl group that can be unsubstituted, partially fluorinated, or fully fluorinated. The inorganic-organic plastic crystal material promotes cation conductivities of more than 10⁻⁷ S/cm at 60° C. And in some variations, the electrolyte includes the composite salt mixture of two or more boron cluster salts, the inorganic-organic plastic crystal, and the one or more additional cation conductivity enhancing anions.

In another variation, an electrolyte is formulated from the composite salt mixture of two or more boron cluster salts noted above, with an addition of an ionic liquid additive in the electrolyte. And in such variations the composite salt mixture of two or more boron cluster salts can be disposed in the ionic liquid and the concentration of the ionic liquid is between 0.01 and 50 molar %.

In one form of the present disclosure, the composite salt mixture of two or more boron cluster salts is included in a solid-state electrolyte for a solid-state electrochemical device. In another form of the present disclosure, an electrolyte with the composite salt mixture of two or more boron cluster salts is in a partially liquid molten state at room temperature (i.e., 20-25° C.). And in still another form, an electrolyte with the composite salt mixture of two or more boron cluster salts is in a fully liquid molten state at room temperature.

In another form of the present disclosure, an inorganic oxide additive filler, e.g., silica or alumina, among others, is blended into the solid state electrolyte composite to achieve a desired solid state consistency of the composite salt and solvent mixture such that greater than 10⁻⁴ S/cm conductivity at 30° C. and low activation energy less than 0.65 eV at one or more temperatures above −30° C. is achieved. The inorganic oxide additive filler content can be in the range of 0.5-30 molar % of total.

In some variations, a composite salt mixture of two or more boron cluster salts with a desired amount of solvent is prepared by combining or mixing appropriate amounts of the two or more boron cluster salts and a predefined amount of the solvent using mechanochemical synthetic ball milling followed by an optional heat treatment of the ball milled material at temperatures less than 200° C. and an optional ball milling homogenization step. In other variations, a composite salt mixture of two or more boron cluster salts with a desired amount of solvent is prepared using solution-based synthesis in which appropriate amounts of the two or more boron cluster solvents salt are dissolved in a solvent (e.g., an ether solvent) followed by removal by at least part of the solvent and an optional ball milling homogenization step.

In some variations, an electrochemical device that includes an anode, a cathode, and an electrolyte with the composite salt mixture of two or more boron cluster salts, with a desired amount of solvent, in contact with the anode and the cathode is provided in the present disclosure. The electrochemical device can be a primary or a secondary battery or a subunit of a secondary battery. The anode is an electrode where oxidation of the anode material occurs during the device's discharge and where reduction occurs during the device's charge. Similarly, the cathode is an electrode where a cathode material reduction occurs during the device's discharge and a cathode material oxidation occurs during the device's charge.

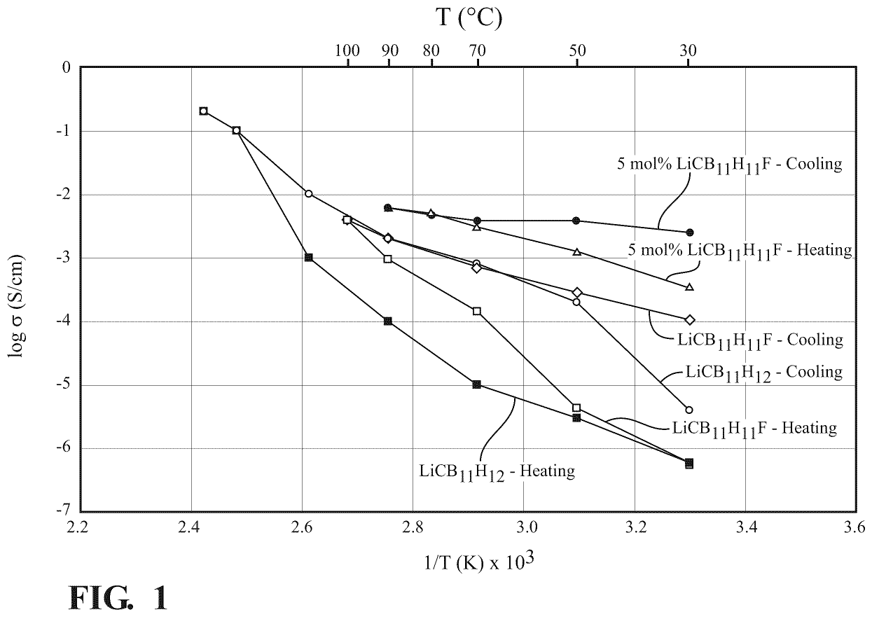

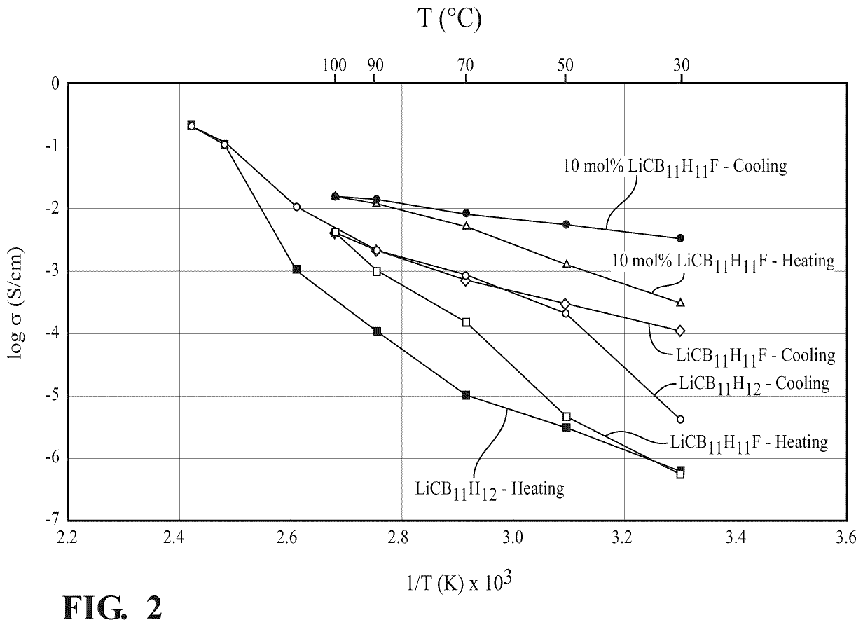

Referring now to FIGS. 1 and 2, Arrhenius plots of conductivity versus temperature for two combined halogen-free boron cluster/halogenated boron cluster salts according to the teachings of the present disclosure are shown. Particularly, FIG. 1 shows an Arrhenius plot for a combined 95 mol % LiCB₁₁H₁₂/5 mol % LiCB₁₁H₁₁F salt subjected to cationic conductivity measurements at 30, 50, 70, 80, and 90° C. during heating of the combined 95 mol % LiCB₁₁H₁₂/5 mol % LiCB₁₁H₁₁F salt (labeled “5 mol % LiCB₁₁H₁₁F—Heating”) and cationic conductivity measurements at 90, 80, 70, 50, and 30° C. following the heating of the combined 95 mol % LiCB₁₁H₁₂/5 mol % LiCB₁₁H₁₁F salt (labeled “5 mol % LiCB₁₁H₁₁F—Cooling”). FIG. 2 shows an Arrhenius plot for a combined 90 mol % LiCB₁₁H₁₂/10 mol % LiCB₁₁H₁₁F salt subjected to cationic conductivity measurements at 30, 50, 70, 90, and 100° C. during heating (labeled “10 mol % LiCB₁₁H₁₁F—Heating”) and cationic conductivity measurements at 100, 90, 70, 50, and 30° C. following the heating of the combined 90 mol % LiCB₁₁H₁₂/10 mol % LiCB₁₁H₁₁F salt (labeled “10 mol % LiCB₁₁H₁₁F—Cooling”). And for comparison, FIGS. 1 and 2 also show cationic conductivities for neat LiCB₁₁H₁₂ and neat LiCB₁₁H₁₁F during heating and cooling.

The combined 95 mol % LiCB₁₁H₁₂/5 mol % LiCB₁₁H₁₁F salt and the combined 90 mol % LiCB₁₁H₁₂/10 mol % LiCB₁₁H₁₁F salt were prepared by mixing LiCB₁₁H₁₂ and LiCB₁₁H₁₁F salts with a mortar and pestle, followed by ball milling at 700 revolutions per minute (RPM) for 24 hours to ensure uniformity of the combined LiCB₁₁H₁₂/LiCB₁₁H₁₁F salts. A solid-state electrolyte pellet for each of the combined LiCB₁₁H₁₂/LiCB₁₁H₁₁F salts was formed by pressing a given LiCB₁₁H₁₂/LiCB₁₁H₁₁F salt mixture under at least 120 MPa of pressure. Also, carbon coated aluminum foil was used as the working electrode and the counter electrode of a two-electrode cell, and a solid-state electrolyte pellet of the combined 95 mol % LiCB₁₁H₁₂/5 mol % LiCB₁₁H₁₁F salt or the combined 90 mol % LiCB₁₁H₁₂/10 mol % LiCB₁₁H₁₁F salt was in direct contact with the working and counter electrodes during cationic conductivity measurements.

Referring particularly to FIG. 1, the combined 95 mol % LiCB₁₁H₁₂/5 mol % LiCB₁₁H₁₁F salt exhibited cationic conductivities of about 3.6×10⁻⁴ S/cm at 30° C. initially and of about 2.2×10⁻³ S/cm at 30° C. after heating. In contrast, the neat LiCB₁₁H₁₂ salt exhibited cationic conductivities initially of about 6.0×10⁻⁷ S/cm at 30° C. and about 4.0×10⁻⁶ at 30° C. after heating. Accordingly, an increase in cationic conductivity of the combined 95 mol % LiCB₁₁H₁₂/5 mol % LiCB₁₁H₁₁F salt after heat treatment and an extremely low activation energy of 0.209 eV, and the cationic conductivity of the combined 95 mol % LiCB₁₁H₁₂/5 mol % LiCB₁₁H₁₁F salt at 30° C. was greater than about 500 to 1000 times the cationic conductivity of the LiCB₁₁H₁₂.

Referring particularly to FIG. 2, the combined 90 mol % LiCB₁₁H₁₂/10 mol % LiCB₁₁H₁₁F salt exhibited cationic conductivities initially of about 3.2×10⁻⁴ S/cm at 30° C. and about 3.2×10⁻³ S/cm at 30° C. following the heating cycle. In contrast, and as noted above, the neat LiCB₁₁H₁₂ salt exhibited cationic conductivities of about 6.0×10⁻⁷ S/cm at 30° C. and about 4.0×10⁻⁶ S/cm at 30° C. following the heating cycle. Accordingly, an increase in cationic conductivity of the combined 90 mol % LiCB₁₁H₁₂/10 mol % LiCB₁₁H₁₁F salt was observed as was an extremely low activation energy of less than 0.3 eV, and the cationic conductivity of the combined 90 mol % LiCB₁₁H₁₂/10 mol % LiCB₁₁H₁₁F salt at 30° C. was greater than about 500 to 1000 times the cationic conductivity of the LiCB₁₁H₁₂.

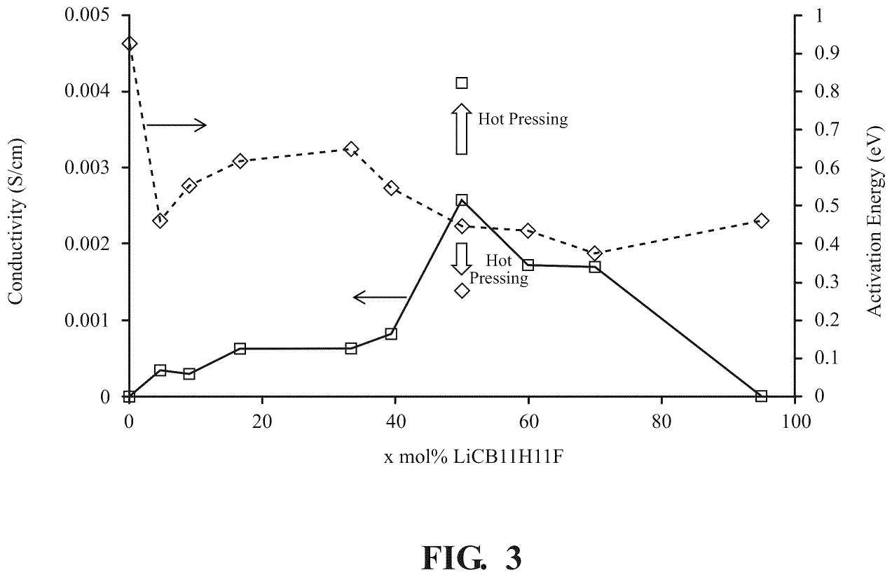

Referring now to FIG. 3, a plot of conductivity at 30° C. (solid line) and activation energy (dashed line) calculated from the temperature range 30-60° C. for a plurality LiCB₁₁H₁₂— LiCB₁₁H₁₁F compositions is shown. The compositions were cold pressed and not subjected to thermal activation, except for the two data points shown for a 50 mol % LiCB₁₁H₁₂—50 mol % LiCB₁₁H₁₁F composition. And as observed from FIG. 3, the conductivity of 100 mol % LiCB₁₁H₁₂ and 5 mol % LiCB₁₁H₁₂—95 mol % LiCB₁₁H₁₁F (solid line) is very low compared to desired compositions of LiCB₁₁H₁₂ and LiCB₁₁H₁₂. For example, compositions such as 50 mol % LiCB₁₁H₁₂—50 mol % LiCB₁₁H₁₁F can be greater than 1000 times that of 100 mol % LiCB₁₁H₁₂ and greater than 1000 times that of 100 mol % LiCB₁₁H₁₁F. In addition, the plot of conductivity versus composition illustrated a specific range or “sweet spot” of compositions that provide enhanced conductivity at 30° C. In some variations the range of compositions that provide enhanced conductivity is between about 60 mol % LiCB₁₁H₁₂— 40 mol % LiCB₁₁H₁₁F and about 20 mol % LiCB₁₁H₁₂ —80 mol % LiCB₁₁H₁₁F, while in other variations the range is between about 55 mol % LiCB₁₁H₁₂—45 mol % LiCB₁₁H₁₁F and about 25 mol % LiCB₁₁H₁₂—75 mol % LiCB₁₁H₁₁F. And in at least one variation the range of compositions that provide enhanced conductivity is between about 55 mol % LiCB₁₁H₁₂—45 mol % LiCB₁₁H₁₁F and about 30 mol % LiCB₁₁H₁₂—70 mol % LiCB₁₁H₁₁F. In addition, the 50 mol % LiCB₁₁H₁₂—50 mol % LiCB₁₁H₁₁F composition was further hot pressed and this hot pressed composition exhibited an even higher conductivity (almost two times greater) compared to the 50 mol % LiCB₁₁H₁₂—50 mol % LiCB₁₁H₁₁F composition without hot pressing.

Still referring to FIG. 3, and regarding the activation energy for the plurality LiCB₁₁H₁₂/LiCB₁₁H₁₁F compositions, all of the tested LiCB₁₁H₁₂/LiCB₁₁H₁₁F compositions that included LiCB₁₁H₁₁F exhibited an activation energy less than 0.65 eV at 30° C. In some variations (i.e., for some compositions), the activation energy was less than 0.61 eV, while in other variations the activation energy was less 0.58 eV. In at least one variation the activation energy was less than 0.51 eV, and in some variations the activation energy was less than 0.47 eV, for example, less than 0.42 eV and less than 0.40 eV. And for the 50 mol % LiCB₁₁H₁₂/50 mol % LiCB₁₁H₁₁F composition that was further hot pressed, this sample exhibited an activation energy less than 0.33 eV.

Accordingly, it should be understood that a simple or random combination of a halogen-free boron cluster salt and a halogenated boron cluster salt does not inherently provide a combined halogen-free boron cluster/halogenated boron cluster salt according to the teachings of the present disclosure. Stated differently, a specific range of compositions according to the teachings of the present disclosure provide a composite salt with enhanced conductivity and low activation energy.

It should also be understood from FIGS. 1, 2, and 3 that the combined halogen-free boron cluster/halogenated boron cluster salts according to the teachings of the present disclosure have or exhibit a cationic conductivity that is at least one order of magnitude greater than a cationic conductivity of the halogen-free boron cluster salt and/or at least one order of magnitude greater than a cationic conductivity of the halogenated boron cluster salt. In some variations, the combined halogen-free boron cluster/halogenated boron cluster salts according to the teachings of the present disclosure have or exhibit a cationic conductivity that is at least two orders of magnitude greater than the cationic conductivity of the halogen-free boron cluster salt and/or at least two orders of magnitude greater than the cationic conductivity of the halogenated boron cluster salt. And in at least one variation, the combined halogen-free boron cluster/halogenated boron cluster salts according to the teachings of the present disclosure have or exhibit a cationic conductivity that is between two and three orders of magnitude greater than the cationic conductivity of the halogen-free boron cluster salt and/or between two and three orders of magnitude greater than the cationic conductivity of the halogenated boron cluster salt, and an activation energy less than 0.65 eV, e.g., less than 0.55 eV, less than 0.45 eV, and/or less than 0.35 eV.

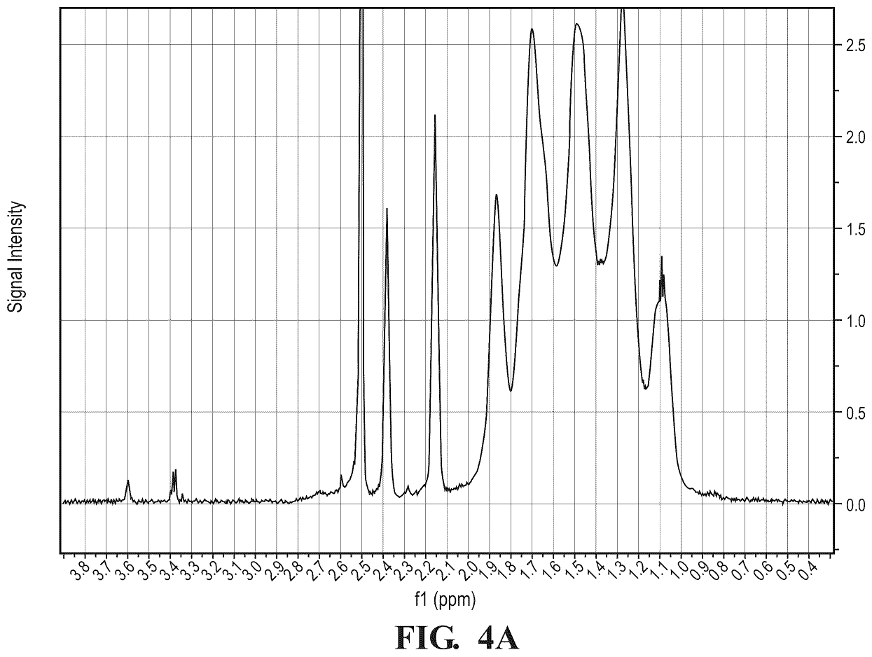

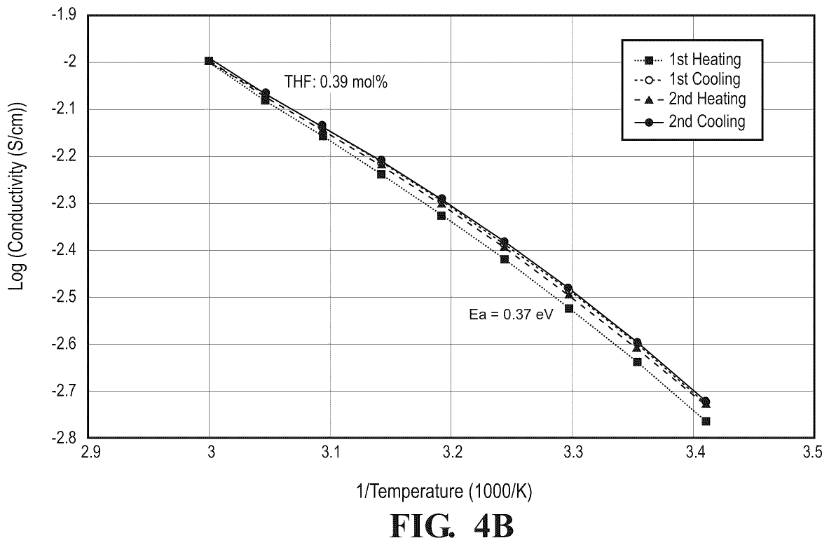

And while FIGS. 1-3 illustrate the enhanced properties of electrolytes with combined binary boron cluster composite salt mixtures, FIGS. 4A-6A illustrate the enhanced properties of electrolytes with composite salt mixtures and a desired amount of solvent as described below.

Referring to FIGS. 4A-4B, FIG. 4A is a ¹H NMR spectrum of a 40 mol % LiCB₁₁H₁₂/60 mol % LiCB₁₁H₁₁F composite salt mixture with 0.39 mol % THF and 0.11 mol % water (H₂O), and FIG. 4B is an Arrhenius plot of conductivity versus inversus temperature for the 40 mol % LiCB₁₁H₁₂/60 mol % LiCB₁₁H₁₁F composite salt mixture with 0.39 mol % THF and 0.11 mol % water. And as observed from FIG. 4A, peaks for THF are present in the ¹H NMR spectrum (ca 3.6 ppm), as are peaks for water. Also FIG. 4B illustrates the trace THF amount has a positive impact on the conductivity of the 40 mol % LiCB₁₁H₁₂/60 mol % LiCB₁₁H₁₁F composite salt mixture and water presence does not impede achieving high conductivities and low activation energies. Particularly, before activation (heating) the 40 mol % LiCB₁₁H₁₂/60 mol % LiCB₁₁H₁₁F composite salt mixture with 0.39 mol % THF and 0.11 mol % water exhibited a conductivity of 2.98 mS/cm at 30° C. and an activation energy (Ea) of 0.37 eV, and after activation a conductivity of 3.25 mS/cm at 30° C. and an activation energy of 0.36 eV. The activation energies were calculated from the Arrhenius plot shown in FIG. 4B at temperatures between 30-60° C.

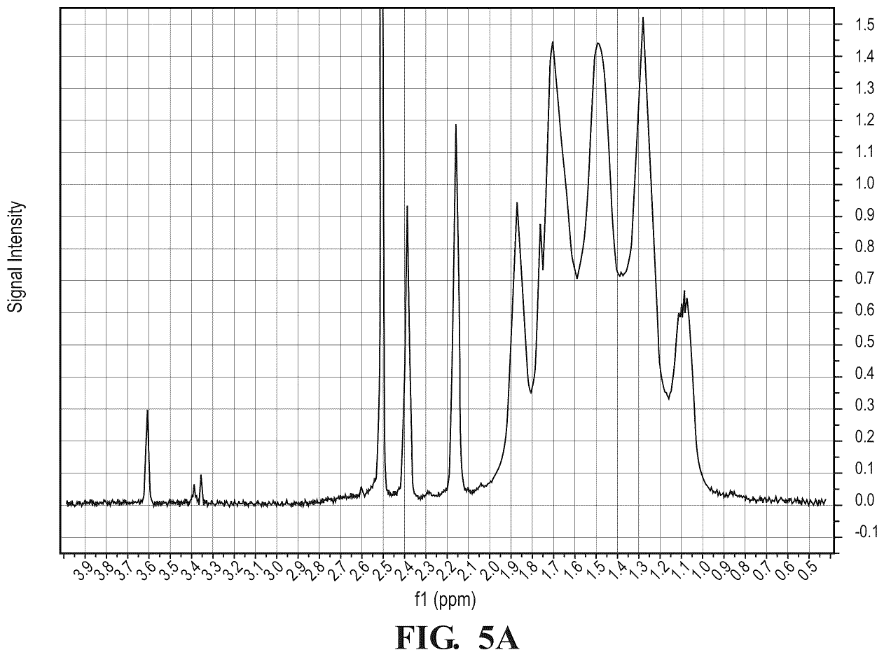

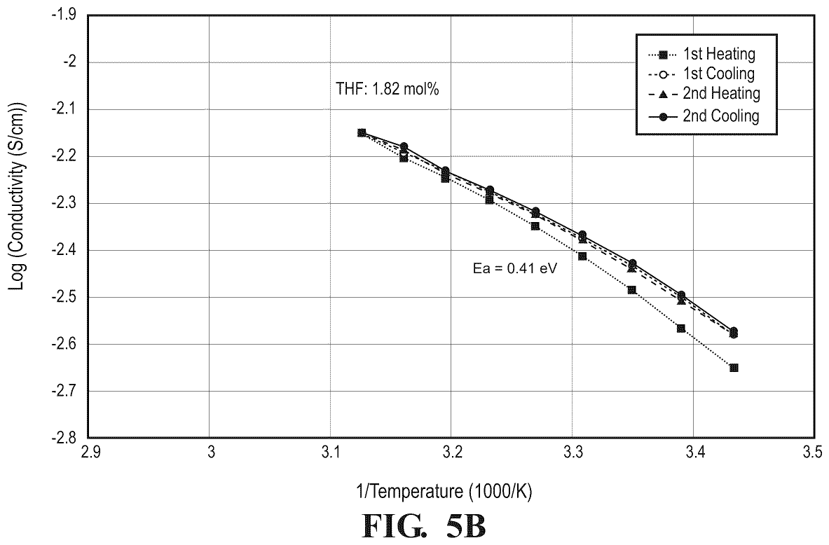

Referring now to FIGS. 5A-5B, FIG. 5A is a ¹H NMR spectrum of a 40 mol % LiCB₁₁H₁₂/60 mol % LiCB₁₁H₁₁F composite salt mixture with 1.82 mol % THF and 0.49 mol % water (H₂O), and FIG. 5B is an Arrhenius plot of conductivity versus inversus temperature for the 40 mol % LiCB₁₁H₁₂/60 mol % LiCB₁₁H₁₁F composite salt mixture with 1.82 mol % THF and 0.49 mol % water. And as observed from FIG. 5B, the increase in THF amount improves the properties of the 40 mol % LiCB₁₁H₁₂/60 mol % LiCB₁₁H₁₁F composite salt mixture after heating to 60° C. Particularly, before activation (heating) the 40 mol % LiCB₁₁H₁₂/60 mol % LiCB₁₁H₁₁F composite salt mixture with 1.82 mol % THF and 0.49% water exhibited a conductivity of 2.90 mS/cm at 30° C. and an activation energy (Ea) of 0.41 eV, and after activation a conductivity of 3.46 mS/cm at 30° C. and an activation energy of 0.37 eV. The activation energies were calculated from the Arrhenius plot shown in FIG. 5B at temperatures between 30-60° C.

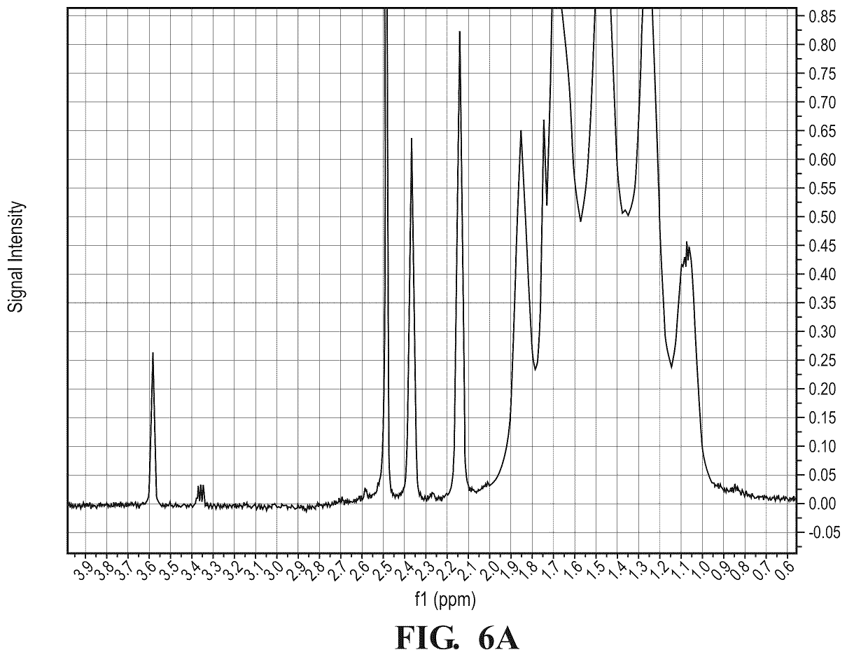

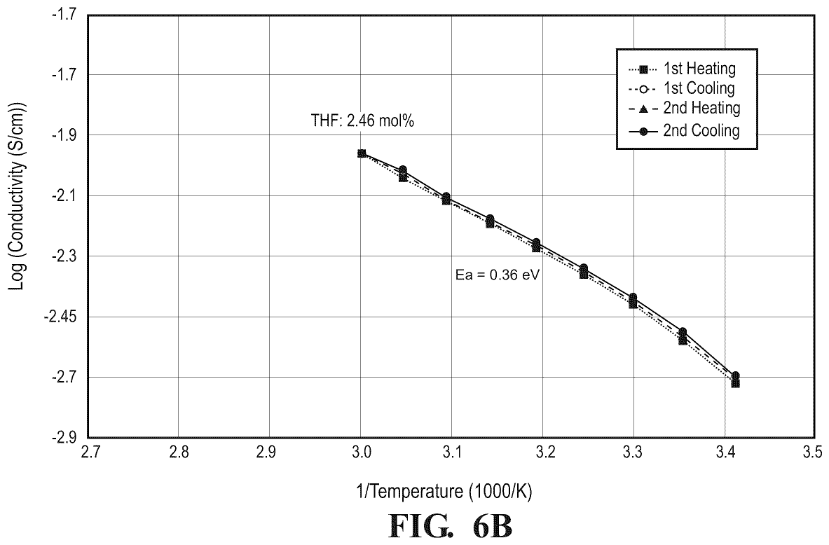

Referring to FIGS. 6A-6B, FIG. 6A is an NMR spectroscopy plot of a 40 mol % LiCB₁₁H₁₂/60 mol % LiCB₁₁H₁₁F composite salt mixture with 2.46 mol % THF and 0.21 mol % water (H₂O), and FIG. 6B is an Arrhenius plot of conductivity versus inversus temperature for the 40 mol % LiCB₁₁H₁₂/60 mol % LiCB₁₁H₁₁F composite salt mixture with 2.46 mol % THF and 0.21 mol % water. And as observed from FIG. 6B, the additional increase in THF amount results in an appreciable positive impact on the conductivity properties of the 40 mol % LiCB₁₁H₁₂/60 mol % LiCB₁₁H₁₁F composite salt mixture. Particularly, before activation (heating) the 40 mol % LiCB₁₁H₁₂/60 mol % LiCB₁₁H₁₁F composite salt mixture with 2.46 mol % THF and 0.21 mol % water exhibited a conductivity of 3.49 mS/cm at 30° C. and an activation energy (Ea) of 0.36 eV, and after activation a conductivity of 3.67 mS/cm at 30° C. and an activation energy of 0.35 eV. The activation energies were calculated from the Arrhenius plot shown in FIG. 6B at temperatures between 30-60° C.

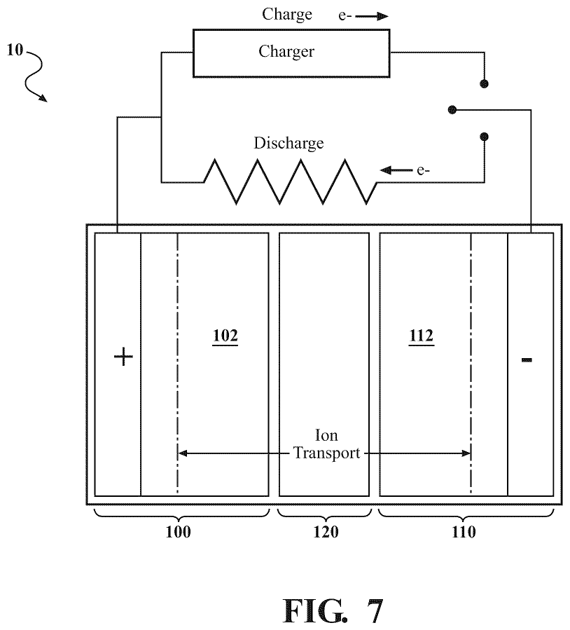

Referring now to FIG. 7, an electrochemical device 10 according to the teachings of the present disclosure is shown. In some variations, the electrochemical device 10 is a solid state electrolyte (SSE) electrochemical device that includes a cathode 100, with or without a catholyte 102, an anode 110, with or without an anolyte 112, and a cell separator (also referred to herein simply as a “separator”) 120. It should be understood that the separator 120 electrically isolates the cathode 100 from the anode 110, but allows ionic conduction therebetween. In some variations, the separator 120 functions as both a ‘separator” between the cathode 100 and the anode 110, and as a solid state electrolyte for the electrochemical device 10. In other variations, a solid state electrolyte can be present between the cathode 100 and the anode 110, in addition to the separator 120.

The cathode 100 can be an insertion cathode, a conversion cathode, or an organic cathode, and the anode 110 can be an intercalation anode, a metal anode, an alloy anode, or an organic anode. The electrochemical device 10 includes the inorganic boron cluster solid state electrolyte according to the teachings of the present disclosure which includes a metal cation selected from Li⁺, Na⁺, K⁺, Mg²⁺, Ca²⁺, Zn²⁺, and Al³⁺, and the combined halogen-free boron cluster/halogenated boron cluster salt(s) mixture discussed above and disclosed herein.

In some variations, the inorganic boron cluster solid state electrolyte as disclosed herein is used as the separator 120, is present in the catholyte 102, and/or is present in the anolyte 112 of the electrochemical device 10. As used herein, the term “catholyte” refers to solid state electrolyte blended in a cathode to enable and/or enhance cationic diffusion in the cathode electrode structure, and the term “anolyte” refers to solid state electrolyte blended in an anode to enable and/or enhance cationic diffusion in the anode electrode structure.

In at least one variation, the separator 120 is not formed from the inorganic boron cluster solid state electrolyte as disclosed herein. Non-limiting examples of such electrolytes include sulfide solid state electrolytes, hydride solid state electrolytes, polymer solid state electrolytes, oxide solid state electrolytes, halide-type solid state electrolytes, plastic crystal solid state electrolytes, inorganic-organic crystal plastic solid state electrolytes, and combinations thereof.

In some variations, the catholyte 102 can be formed only from the inorganic boron cluster solid state electrolyte as disclosed herein, or in the alternative the catholyte 102 can include the inorganic boron cluster solid state electrolyte as disclosed herein in combination with another solid state electrolyte, that is not an inorganic boron cluster based electrolyte, such as sulfide solid state electrolytes, hydride solid state electrolytes, polymer solid state electrolytes, oxide solid state electrolytes, halide-type solid state electrolytes, plastic crystal solid state electrolytes, inorganic-organic plastic crystal solid state electrolytes, and combinations thereof.

Similarly, the anolyte 112 can be formed only from the inorganic boron cluster solid state electrolyte as disclosed herein, or in the alternative the anolyte 112 can include the inorganic boron cluster solid state electrolyte as disclosed herein in combination with other solid state electrolytes, that is not an inorganic boron cluster based electrolyte disclosed herein, such as sulfide solid state electrolytes, hydride solid state electrolytes, polymer solid state electrolytes, oxide solid state electrolytes, halide-type solid state electrolytes, plastic crystal solid state electrolytes, inorganic-organic plastic crystal solid state electrolytes, and combinations thereof.

The inorganic boron cluster solid state electrolyte in the electrochemical device 10 exhibits high compatibility with the anode 110, including metallic anodes such as Li, Na, K, Mg, Ca, Zn and Al, alloy anodes such as Si and Sn alloy anodes, conversion anodes, organic anodes and intercalation anodes such as graphite anodes. For example, the inorganic boron cluster solid state electrolyte supports a cycling coulombic efficiency (CE) greater than 90% with the above noted anodes. The inorganic boron cluster solid state electrolyte also exhibits high compatibility with the cathodes noted above, e.g., a conversion cathode such as a sulfur cathode.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should be also understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. An electrolyte comprising:
a composite salt mixture comprising between 0.975 and 0.05 mole fraction, relative to a total anion content of the composite salt mixture, of a halogen-free boron cluster salt and between 0.025 and 0.95 mole fraction, relative to the total anion content of the composite salt mixture, of a halogenated boron cluster salt;
a solvent content between 0.01 mol % and 100 mol % relative to a total cation content of the electrolyte; and
an activation energy less than 0.65 eV at one or more temperatures above −30° C.

2. The electrolyte according to claim 1, wherein the solvent is selected from the group consisting of an ether solvent, an amine solvent, an amide solvent, a sulfoxide solvent, a sulfone solvent, a sulfonamide solvent, a ketone, a phosphate, a phosphite, a carbonate solvent, a nitrile solvent, an ester solvent, an aliphatic solvent, an aromatic hydrocarbon solvent, an ion-solvating oligomer, an ion-solvating polymer, protic solvent such as water, acetone, alcohol, ammonia and combinations thereof.

3. The electrolyte according to claim 2, wherein:
the halogen-free boron cluster salt comprises:
a monovalent or a multivalent cation and a boron cluster anion having a structure selected from the group consisting of:
[B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, and [C₂B_{(y-3)}H_{(y-t-1)}Rₜ]²⁻, and wherein:
y is an integer within a range of 6 to 12;
(z) is an integer within a range of 0 toy;
(t) is an integer within a range of 0 to (y-1); and
R is a linear, branched-chain, or cyclic C1-C18 alkyl or fluoroalkyl group; and
the halogenated boron cluster salt comprises:
a monovalent or a multivalent cation and a halogenated boron cluster anion having the structure selected from the group consisting of:
[B_{y}H_{(y-z-i)}R_{z}X,]²⁻, [CB_{(y-1)}H_{(y-z-i)}R_{z}X,]⁻, [C₂B_{(y-2)}H_{(y-t-j-1)}RₜXⱼ]⁻, [C₂B_{(y-3)}H_{(y-t-j)}RₜXⱼ]⁻, and [C₂B_{(y-3)}H_{(y-t-j-1)}RₜXⱼ]²⁻, and wherein:
y is an integer within a range of 6 to 12;
(z+i) is an integer within a range of 0 toy;
′(t+j) is an integer within a range of 0 to (y-1);
X is F, Cl, Br, I, halogenated alkyl group including CF₃, or a combination thereof, and
R is a linear, branched-chain, or cyclic C1-C18 alkyl or fluoroalkyl group.

4. The electrolyte according to claim 3, wherein the monovalent or multivalent cation of the halogen-free boron cluster salt are selected from the group consisting of Li⁺, Na⁺, K⁺, Mg²⁺, Ca²⁺, Zn²⁺ and Al³⁺, and the monovalent or multivalent cation of the halogenated boron cluster salt are selected from the group consisting of Li⁺, Na⁺, K⁺, Mg²⁺, Ca²⁺, Zn²⁺ and Al³⁺.

5. The electrolyte according to claim 4 further comprising at least one cation conductivity enhancing anion selected from the group consisting of F⁻, Cl⁻, Br⁻, I⁻, RₓBF₄₋ₓ⁻, R_{y}PF_{6-y}⁻, SbF₆⁻, ClO₄⁻, SO₄²⁻, N(SO₂F)₂⁻, N(SO₂(CF₂)ₙCF₃)₂⁻, [NSO₂(CF₂)ₙ₊₁SO₂]⁻, CF₃(CF₂)ₙSO₃⁻, and combinations thereof, where: n is 0 to 5; x is 0 to 4; y is 0 to 6; and R is a linear, branched, or cyclic alkyl group that can be unsubstituted, partially fluorinated, or fully fluorinated.

6. The electrolyte according to claim 1 further comprising an organic plastic crystal and wherein the composite salt mixture is disposed in the organic plastic crystal.

7. The electrolyte according to claim 6, wherein the organic plastic crystal comprises a succinonitrile-glutaronitrile mixture.

8. The electrolyte according to claim 6, wherein a content of the organic plastic crystal is between 0.01 and 50 mol % of the electrolyte.

9. The electrolyte according to claim 1 further comprising an ionic liquid additive and wherein the composite salt mixture is disposed in the ionic liquid additive.

10. The electrolyte according to claim 9, wherein a content of the ionic liquid additive is between 0.01 and 50 molar % of the electrolyte.

11. The electrolyte according to claim 1 further comprising an inorganic oxide additive filler blended into the composite salt mixture.

12. The electrolyte according to claim 11, where in the inorganic additive filler has a content between 0.5 to 30 molar % and is selected from the group consisting of silica, alumina, and combinations thereof.

13. An electrochemical cell comprising an anode, a cathode, and the electrolyte according to claim 1.

14. An electrochemical cell comprising:
an anode, a cathode, and a solid state electrolyte comprising:
a composite salt mixture comprising between 0.975 and 0.05 mole fraction, relative to a total anion content of the composite salt mixture, of a halogen-free boron cluster salt and between 0.025 and 0.95 mole fraction, relative to the total anion content of the composite salt mixture, of a halogenated boron cluster salt of the solid state electrolyte;
a solvent content between 0.01 and 100 mol % relative to a total cation content of the solid state electrolyte; and
an activation energy less than 0.65 eV at one or more temperatures above −30° C.

15. The electrochemical cell according to claim 14, wherein the solvent is selected from the group consisting of an ether solvent, an amine solvent, an amide solvent, a sulfoxide solvent, a sulfone solvent, a sulfonamide solvent, a ketone, a phosphate, a phosphite, a carbonate solvent, a nitrile solvent, an ester solvent, an aliphatic solvent, an aromatic hydrocarbon solvent, an ion-solvating oligomer, an ion-solvating polymer, protic solvent such as water, acetone, alcohol, ammonia and combinations thereof.

16. The electrochemical cell according to claim 15, wherein:
the halogen-free boron cluster salt comprises:
a monovalent or a multivalent cation and a boron cluster anion having a structure selected from the group consisting of:
[B_{y}H_{(y-z)}R_{z}]²⁻, [CB_{(y-1)}H_{(y-z)}R_{z}]⁻, [C₂B_{(y-2)}H_{(y-t-1)}Rₜ]⁻, [C₂B_{(y-3)}H_{(y-t)}Rₜ]⁻, and [C₂B_{(y-3)}H_{(y-t-1)}Rₜ]²⁻, and wherein:
y is an integer within a range of 6 to 12;
(z) is an integer within a range of 0 toy;
(t) is an integer within a range of 0 to (y-1); and
R is a linear, branched-chain, or cyclic C1-C18 alkyl or fluoroalkyl group; and
the halogenated boron cluster salt comprises:
a monovalent or a multivalent cation and a halogenated boron cluster anion having the structure selected from the group consisting of:
[B_{y}H_{(y-z-i)}R_{z}X,]²⁻, [CB_{(y-1)}H_{(y-z-i)}R_{z}X,]⁻, [C₂B_{(y-2)}H_{(y-t-i-1)}RₜXⱼ]⁻, [C₂B_{(y-3)}H_{(y-t-j)}RₜXⱼ]⁻, and [C₂B_{(y-3)}H_{(y-t-j-1)}RₜXⱼ]²⁻, and wherein:
y is an integer within a range of 6 to 12;
(z+i) is an integer within a range of 0 toy;
(t+j) is an integer within a range of 0 to (y-1);
X is F, Cl, Br, I, halogenated alkyl group including CF₃, or a combination thereof, and
R is a linear, branched-chain, or cyclic C1-C18 alkyl or fluoroalkyl group.

17. The electrochemical cell according to claim 16, wherein the monovalent or multivalent cation of the halogen-free boron cluster salt are selected from the group consisting of Li⁺, Na⁺, K⁺, Mg²⁺, Ca²⁺, Zn²⁺ and Al³⁺, and the monovalent or multivalent cation of the halogenated boron cluster salt are selected from the group consisting of Li⁺, Na⁺, K⁺, Mg²⁺, Ca²⁺, Zn²⁺ and Al³⁺.

18. The electrochemical cell according to claim 17 further comprising at least one cation conductivity enhancing anion is selected from the group consisting of F⁻, Cl⁻, Br⁻, I⁻, RₓBF₄₋ₓ⁻, R_{y}PF_{6-y}⁻, SbF₆⁻, ClO₄⁻, SO₄²⁻, N(SO₂F)₂⁻, N(SO₂(CF₂)ₙCF₃)₂⁻, [NSO₂(CF₂)ₙ₊₁SO₂]⁻, CF₃(CF₂)ₙSO₃⁻, and combinations thereof, where: n is 0 to 5; x is 0 to 4; y is 0 to 6; and R is a linear, branched, or cyclic alkyl group that can be unsubstituted, partially fluorinated, or fully fluorinated.

19. A method comprising:
mixing a halogen-free boron cluster salt, a halogenated boron cluster salt, and solvent in a mechanochemical synthetic ball mill and forming an inorganic boron cluster solid state electrolyte, the halogen-free boron cluster salt comprising between 0.975 and 0.05 mole fraction relative to a total anion content of the solid state electrolyte, the halogenated boron cluster salt comprising between 0.025 and 0.95 mole fraction relative to the total anion content of the solid state electrolyte, and the solvent comprising between 0.01 and 100 mol % relative to a total cation content of the solid state electrolyte, wherein the inorganic boron cluster solid state electrolyte, when heated to a temperature at or below 200° C. and cooled, has an activation energy that is less than an activation energy of the solid state electrolyte before being heated.

20. The method according to claim 19, wherein prior mixing the halogen-free boron cluster salt, the halogenated boron cluster salt, and the solvent in the mechanochemical synthetic ball mill, a premixing step is applied for the halogen-free boron cluster salt, the halogenated boron cluster salt, and the solvent in a mortar and pestle followed by heating up to 150° C. for up to 24 hours.
